(19) United States
(12) Patent Application Publication
(10) Pub. No.: US 2023/0341886 A1
(43) Pub. Date: Oct. 26, 2023

(54) JOYSTICK, CONTROLLER, AND ARCADE MACHINE

(71) Applicant: QANBA USA, LLC, Daly City, CA (US)

(72) Inventors: Xianglong Zhong, Shenzhen (CN); Guanghua Tan, Shenzhen (CN)

(21) Appl. No.: 17/965,646

(22) Filed: Oct. 13, 2022

(30) Foreign Application Priority Data
Apr. 24, 2022 (CN) 202210432994.9
Apr. 24, 2022 (CN) 202220957276.9

(51) Int. Cl. G05G 9/047; A63F 13/98; G05G 9/053

(52) U.S. Cl. CPC G05G 9/04785; A63F 13/98; G05G 9/053; G05G 2009/04744

(57) ABSTRACT

A joystick includes: a base; a joystick shaft, four micro-switches, and a retaining ring. The joystick shaft is in operable connection with the base, and is surrounded by a trigger member and a limit member. The four micro-switches are fixed on the base, and are located in four cardinal directions of the trigger member, and four ordinal directions are formed between every two adjacent micro-switches. Each of the micro-switches is a mechanical-shaft-key switch. The retaining ring is configured to limit rotation angles of the joystick shaft. According to the joystick of the present application, the noise caused by the joystick can be effectively reduced, and the service life of the joystick can be prolonged, the directional output control in eight directions can be realized, and it is ensured that the micro-switches in the cardinal directions will not be damaged when the joystick performs the control operation in the ordinal directions.

### CROSS-REFERENCE TO RELATED APPLICATION(S)

This application claims priority to Chinese Patent Applications No. 202210432994.9 and No. 202220957276.9, both filed on Apr. 24, 2022 with the Patent Office of China, the entire contents of both of which are incorporated herein by reference.

### BACKGROUND

### 1. Field

The present application relates to the field of joystick technology, and more particularly, to a joystick, a controller and an arcade machine.

### 2. Description of the Related Art

Actions in games can be controlled through directional outputs of a joystick shaft of a joystick. The joystick specifically includes a joystick ball, a joystick shaft, four micro-switches and a circuit board. The four micro-switches are located in four forward directions of the joystick shaft, i.e., front, rear, left and right directions, and four oblique directions are respectively formed between every two adjacent micro-switches, i.e., front-left, rear-left, front-right and rear-right directions. The four micro-switches are electrically connected to the circuit board, corresponding to controls in eight directions, namely, the four forward directions and the four oblique directions. The joystick ball moves in a specific direction to drive the joystick shaft to rotate and then trigger one or two micro-switches, to output a corresponding direction control through the circuit board. For example, when the joystick ball is moved forward, the joystick shaft is driven to rotate and then the micro-switch located directly behind is triggered, thereby a forward direction control for actions in a game is output by the circuit board. For example, when the joystick ball is moved towards a front-right direction, the joystick shaft is driven to rotate and then the two micro-switches located on left and rear directions are triggered, thereby a front-right direction control for actions in the game is output by the circuit board.

In the existing joysticks, spring members are applied in the micro-switches for micro motions, where a micro-spring has a spring member and a contact point. The micro-switch can be triggered when the joystick shaft presses the spring member against the contact point. Since the micro-switch has a larger length of the spring member (compared to the size of the contact point), the joystick shaft can conveniently and effectively trigger the micro-switches for actions in forward and oblique directions after the four micro-switches are arranged around the joystick shaft, thereby enabling directional outputs in eight directions. However, the use of spring members for micro motions has a problem of high noise, especially when the joystick is used at home at night, the noise of the joystick will affect the rest of family members and neighbors.

### SUMMARY

To achieve the above objective, technical solutions involved in the embodiments of the present application are as follows:

A joystick is provided, which includes: a base, a joystick shaft, four micro-switches and a retaining ring. The joystick shaft is in operable connection with the base, and the joystick shaft is surrounded by a trigger member and a limit member. The four micro-switches are fixed on the base, and are located in four cardinal directions of the trigger member, and four ordinal directions are formed between every two adjacent micro-switches. Each of the micro-switches is a mechanical-shaft-key switch and includes a fixed seat and a key shaft protruding from the fixed seat. The key shaft, when being pressed by the trigger member, enables the micro-switch to be triggered. The retaining ring is configured to limit rotation angles of the joystick shaft. The joystick shaft has a cardinal rotation angle and an ordinal rotation angle. The cardinal rotation angle is a maximum rotation angle of the joystick shaft in any of the cardinal directions, and the ordinal rotation angle is a maximum rotation angle of the joystick shaft in any of the ordinal directions.

Optionally, the cardinal rotation angle and the ordinal rotation angle meet a relational expression expressed as tan θ1=K*tan θ2, where 0.67≤K<1, θ1 is the cardinal rotation angle of the joystick shaft, and θ2 is the ordinal rotation angle of the joystick shaft.

Optionally, the joystick satisfies: the cardinal rotation angle is greater than the ordinal rotation angle, the cardinal rotation angle is in a range of 7.5°-9°, and the ordinal rotation angle is in a range of 8.1°-11°.

Optionally, the trigger member is cylindrical and a gap between an outer surface of the trigger member and the key shaft is in a range of approximately 0 mm-approximately 0.8 mm.

Optionally, the trigger member is cylindrical and a gap between an outer surface of the trigger member and the key shaft is in a range of approximately 0.1 mm-approximately 0.3 mm.

Optionally, the trigger member is cylindrical and a following relational expression expressed as 0.95 r/B is met, where r is a radius of the trigger member, and B is a distance from a surface of the key shaft facing the trigger member to a center of the joystick shaft.

Optionally, a periphery of each fixed seat is provided with a fixed rib, and the base is correspondingly provided with fixed slots matched with the fixed rib.

Optionally, the base includes a base plate and four fasteners connected to the base plate and arranged to correspond to the four micro-switches, wherein each of the four fasteners includes a first baffle and a second baffle, the first baffle and the second baffle are located on two sides of one of the four micro-switches, and the first baffle and the second baffle each include a fixed slot.

Optionally, the joystick includes a circuit board, and the micro-switches are electrically connected to the circuit board through conductive strips. One end of the conductive strip facing away from the circuit board is provided with a plug-in groove, and when the fixed strip is inserted into and in engagement with fixed slots, pins of the micro-switches are inserted into the plug-in grooves.

A controller is provided, which includes the joystick as described above.

An arcade machine is provided, which includes the joystick as described above.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features may be combined with one or more other described features to provide a workable joystick, a workable controller including a joystick, or a workable arcade machine including a joystick.

### BRIEF DESCRIPTION OF THE DRAWINGS

In order to illustrate solutions in embodiments of the present application more clearly, the following will briefly introduce the drawings that need to be used for describing the embodiments or the existing technologies. The drawings in the following description are merely some embodiments of the present application.

FIG. 1 is an overall structural diagram of a joystick in accordance with an embodiment of the present application;

FIG. 2 is a sectional view of the structure shown in FIG. 1;

FIG. 3 is a schematic sectional view of a joystick shaft that is rotated in a forward direction in accordance with an embodiment of the present application;

FIG. 4 is a partial dismantling schematic diagram of the structure shown in FIG. 1;

FIG. 5 is a structural diagram of a base in accordance with an embodiment of the present application;

FIG. 6 is an assembly diagram of the base, micro-switches and a circuit board in accordance with an embodiment of the present application;

FIG. 7 is a first schematic diagram of a micro-switch in accordance with an embodiment of the present application;

FIG. 8 is a second schematic diagram of the micro-switch in accordance with an embodiment of the present application; and

FIG. 9 is a schematic diagram of the micro-switches being triggered through a rotation of a trigger member in accordance with an embodiment of the present application.

### DETAILED DESCRIPTION

The present disclosure relates to various embodiments of a joystick, a controller including the joystick, and an arcade machine including the joystick. The joystick, the controller, and the arcade machine according to various embodiments of the present disclosure include mechanical-shaft-key switches that are configured to achieve directional output controls in eight directions while reducing the noise caused by operations of the joystick and prolonging the service life of the joystick compared to related art joysticks with shrapnel micro-switches. The joystick, the controller, and the arcade machine according to various embodiments of the present disclosure are also configured to limit the rotation angle of the joystick shaft compared to related art joysticks such that the micro-switches in the cardinal directions (front, back, left, and right) will not be damaged when the joystick performs control operations in the ordinal directions (front-left; front-right; back-left; and back-right).

In order to illustrate the problems to be solved, schemes and advantages of the present application more clearly, the present application will be further described in detail below with reference to the drawings and embodiments. It should be understood that specific embodiments described herein are intended only to explain the present application, but not to limit the present application.

It should be noted that when a component is referred to as being “fixed to” or “disposed on” another component, it may be directly or indirectly on the other component. When an element is referred to as being “connected to” another element, it may be directly or indirectly connected to the other element.

It should be understood that orientation or positional relationship indicated by terms “length”, “width”, “upper”, “lower”, “front”, “rear”, “left”, “right”, “vertical”, “horizontal”, “top”, “bottom”, “inside”, “outside”, etc. is based on the orientation or positional relationship shown in the drawings, and is only for the convenience of describing the present application and simplifying the description, rather than indicating or implying the device or element referred to must have a particular orientation, be constructed or operated in a particular orientation, and thus should not be construed as a limitation to the present application.

In addition, the terms “first” and “second” are used only for descriptive purposes, and should not be construed as indicating or implying relative importance or implying the number of the indicated feature. Thus, a feature defined with “first” or “second” may expressly or implicitly include one or more of that feature. In the description of the present application, a phrase “a/the plurality of” means two or more, unless otherwise expressly and specifically defined.

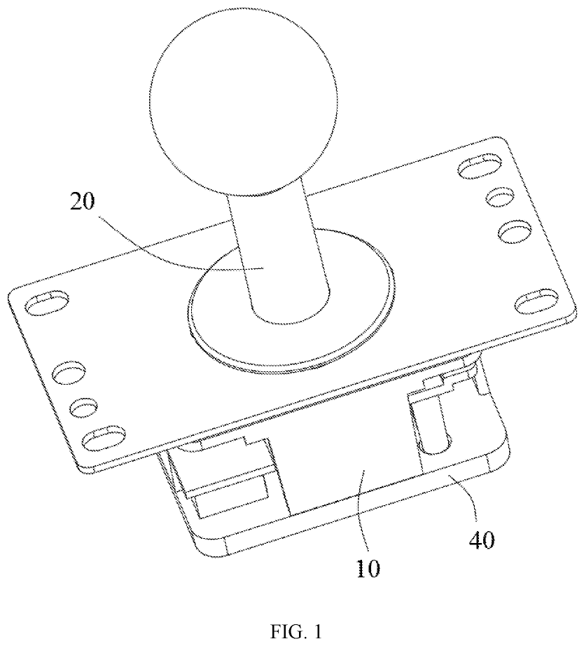

Referring to FIG. 1 to FIG. 9, a joystick, a controller having the joystick, and an arcade machine having the joystick, provided by the present application are exemplarily described.

The joystick includes a base 10, a joystick shaft 20 in operable connection with the base 10, and a micro-switch 30 fixed on the base 10. In the illustrated embodiment, the joystick also includes a circuit board 50 and a retaining ring 40.

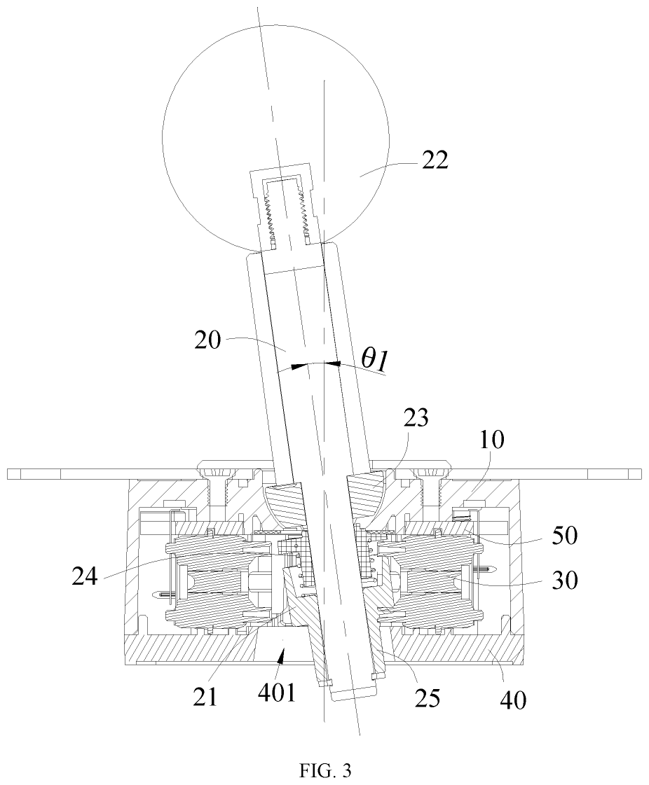

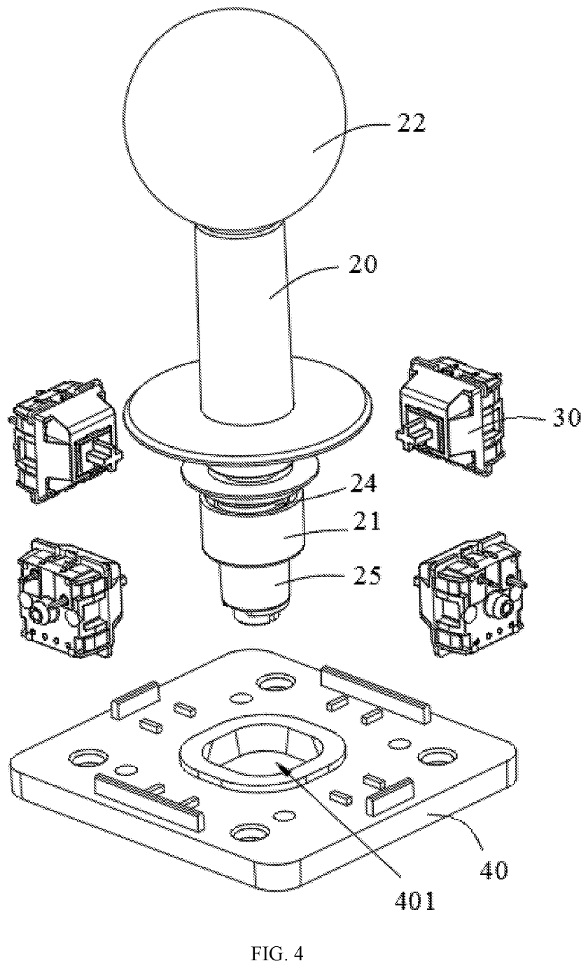

Referring to FIG. 3 and FIG. 4, a joystick ball 22 is fixed on a top of the joystick shaft 20. The joystick ball 22 is configured for push-pull and rotation operations by hand. The joystick ball 22 and the joystick shaft 20 may be integrally formed with the same material, or may be two structural parts that are fixedly connected by welding or other methods, or two structural parts that are connected by screwing, which will not be limited here.

A hemispherical member 23 extends around an outer surface of the joystick shaft (i.e., is sleeved on the joystick shaft 20), and a spherical groove that cooperates with the hemispherical member 23 is formed on a base plate 11. The hemispherical member 23 is placed in the spherical groove and can be rotated in a universal direction relative to the spherical groove, such that the joystick shaft 20 can be rotated in a universal direction relative to the base plate 11. A spherical center of the spherical groove/hemispherical member 23 is a rotation center of the joystick shaft 20.

A return member 24 also extends around an outer surface of the joystick shaft 20 (i.e., is also sleeved on the joystick shaft 20), and the return member 24 is an elastic member, such as a spring. The return member 24 is configured to maintain a centered state that the joystick shaft 20 is perpendicular to the base plate 11. That is, the return member 24 is configured to bias the joystick shaft 20 to be perpendicular to the base plate 11. The joystick shaft 20 is rotated under the action of external force, and the return member 24 is elastically deformed. After the external force disappears, the joystick shaft 20 is restored to the centered state due to an elastic restoring force of the return member 24.

A trigger member 21 and a limit member 25 also extend around an outer surface of the joystick shaft 20 (i.e., are sleeved on the joystick shaft 20). The trigger member 21 is configured to press against the micro-switch 30, and the limit member 25 in cooperation with the retaining ring 40 are configured to limit a rotation angle of the joystick shaft 20. In this embodiment, the trigger member 21 and the limit member 25 are integrally provided. In other embodiments, the trigger member 21 and the limit member 25 may also be two independent structural members fixed on the joystick shaft 20 by welding or clamping, or any other suitable means which will are not limited herein.

In combination with the orientation shown in FIG. 4, the joystick ball 22 is located at the top of the joystick shaft 20, and the hemispherical member 23, the middle member 24, the trigger member 21, and the limit member 25 are arranged sequentially on the joystick shaft 20 along a direction from top to bottom. The joystick ball 22, the hemispherical member 23, the middle member 24, the trigger member 21, and the limit member 25 rotate synchronously with the rotation of the joystick shaft 20.

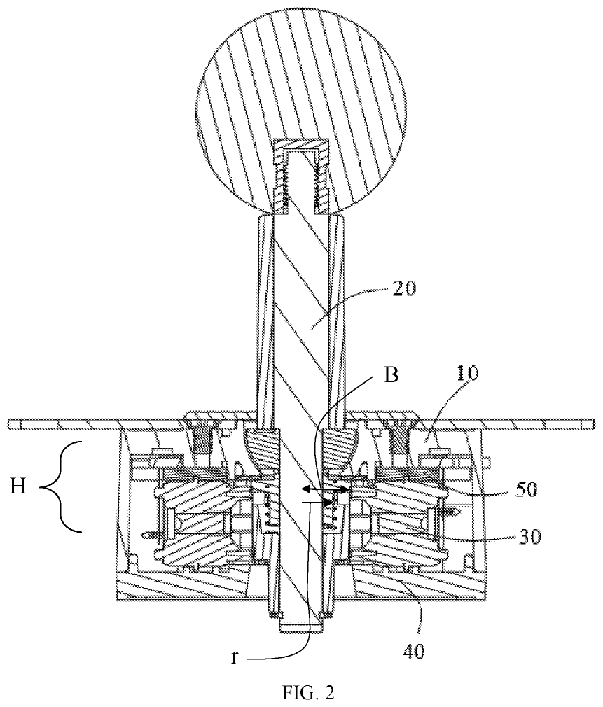

Referring to FIG. 2 and FIG. 4, four micro-switches 30 are disposed around (e.g., equidistantly or substantially equidistantly around) the joystick shaft 20, and the micro-switches 30 are electrically connected to the circuit board 50, through wires, conductive sheets 51 or other conductors. The micro-switch 30 has two states, on and off. Under normal placement, the micro-switches 30 are in the off state, and when the micro-switch 30 is triggered, a direction signal is sent by the micro-switch 30 to the circuit board 50. The circuit board 50 is configured to receive the direction signal and output a corresponding direction control for the game.

Referring to FIG. 3 and FIG. 4, the retaining ring 40 is detachably connected to the base 10. The retaining ring 40 is configured to limit the rotation angles of the joystick shaft 20. In this embodiment, the retaining ring 40 is connected to the base 10 through fasteners. In other embodiments, the retaining ring 40 and the base 10 may also be connected through a snap connection or other manners, which will not be limited herein. In this embodiment, the retaining ring 40 and the base 10 are located on two sides (e.g., opposite sides) of the micro-switches 30, and the retaining ring 40 and the base 10 are detachably connected to enclose and fix the micro-switches 30 therein. The retaining ring 40 is detachably connected to the base 10, which facilitates the assembly and later maintenance of the micro-switches 30. A limit hole 401 is defined in a center of the retaining ring 40, and the maximum angle that the joystick shaft 20 can rotate is limited by the limit hole 401, thereby effectively preventing the micro-switches 30 from being damaged by an excessive rotation angle of the joystick shaft 20.

Taking the horizontal placement of the base 10 as a reference, the four micro-switches 30 are located in four cardinal directions of the joystick shaft 20: front, rear, left and right, and four oblique (i.e., ordinal) directions are respectively formed between every two adjacent micro-switches 30: left-front, left-rear, right-front, and right-rear. The four micro-switches 30 are electrically connected to the circuit board 50, corresponding to controls in eight directions, namely, the four cardinal directions and the four ordinal directions. The joystick ball 22, due to an external force, is moved in a specific direction to drive the joystick shaft 20 to rotate, thereby triggering one or two micro-switches 30, and then a corresponding direction control is output by the circuit board 50. For example, when the joystick ball 22 is moved forward, the joystick shaft 20 is rotated to trigger the micro-switch 30 located directly behind the joystick shaft 20, and the circuit board 50 outputs a direction control of the game moving forward. For example, when the joystick ball 22 is moved towards a right-front direction, the joystick shaft 20 is rotated to trigger the two micro-switches 30 located at the left and rear sides, and the circuit board 50 outputs a direction control of the game moving towards the right-front direction.

In this embodiment, each micro-switch 30 is a mechanical shaft key and includes a fixed seat 31 and a key shaft 32 protruding from the fixed seat 31, and the joystick shaft 20 is driven to rotate relative to the base 10 to press the key shaft 32 of one or two micro-switches 30 to trigger the one or two micro-switches 30.

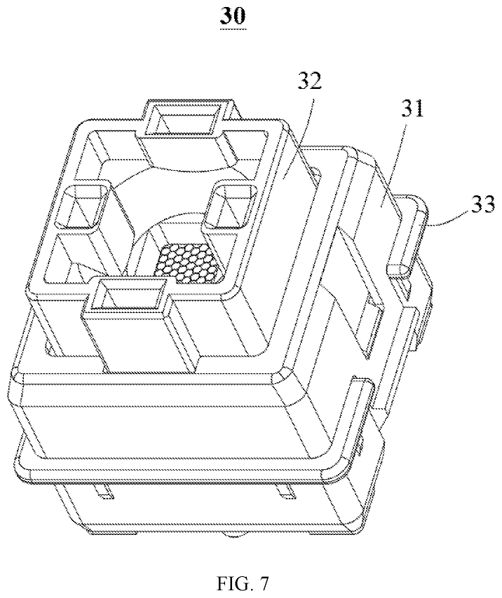

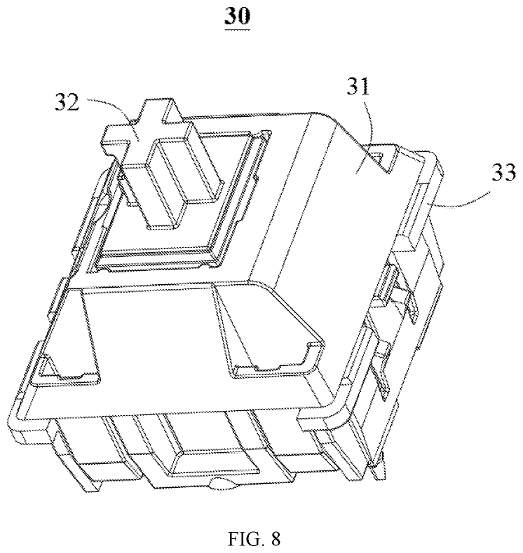

In one or more embodiments, the mechanical-shaft-key switch may be an existing structure, and may be selected as brown shaft, green shaft, white shaft, black shaft, red shaft, silver shaft, etc., that are commonly used in computer mechanical keyboards. FIGS. 7 and 8 show two types of mechanical-shaft-key switches. The mechanical-shaft-key switch includes a fixed seat 31, a key shaft 32, a spring and a pin. The key shaft 32, the spring and the pin are arranged on the fixed seat 31. The key shaft 32 is slidably connected to the fixed seat 31. Two pins are provided, one of which is an elastic piece, and when the elastic piece touches the other pin, the micro-switch 30 is triggered. An insert piece is provided on the key shaft 32, and the key shaft 32 is elastically connected to the fixed seat 31 through a spring. When no external force is applied, the two pins are separated by the insert piece of the key shaft 32, and the micro-switch 30 is in a closed state. When no external force is applied, the elastic piece is in an elastic deformation state. When the key shaft 32 is pressed into the fixed seat 31 under the action of an external force (e.g., a user pressing or pulling on the joystick ball 22), the insert piece is moved downward, and the elastic piece is reset under the action of the elastic restoring force and abuts against another pin, thereby triggering the micro-switch 30. After the external force is removed, the key shaft 32 is reset under the action of the spring and then the micro-switch 30 returns to the closed state.

The mechanical-shaft-key switch works in low voltage (e.g., 3.3V˜5V) and weak current (e.g., 1 mA˜10 mA), which has characteristics of no mechanical noise (or substantially no mechanical noise) and long service life (e.g., 70 million operations).

In the joystick, the controller and the arcade machine, provided by the present application, the mechanical-shaft-key switches replace the conventional shrapnel micro-switches 30, which can effectively reduce the noise caused by the joystick and prolong the service life of the joystick.

In this embodiment, the retaining ring 40 has a limit hole 401, and a rotation of the joystick shaft 20 is further limited when the limit member 25 is in contact with a hole wall (e.g., a rim) of the limit hole 401. In other words, the maximum angle that the joystick shaft can rotate is limited by the engagement of the limit member 25 with the hole wall of the limit hole 401. For example, when the joystick ball 22 is moved to the left by a human hand, the joystick shaft 20 is rotated to the left with respect to a center of the hemispherical member 23 that serves as a center of rotation, and the micro-switch 30 on the right side of the trigger member 21 is pressed by the trigger member 21, thereby triggering this micro-switch 30. When the joystick shaft 20 is rotated to the left to a certain angle, the limit member is in contact with the retaining ring 40 to limit the further rotation of the joystick shaft 20. The certain angle is the maximum angle that the joystick shaft 20 can rotate in this direction (e.g., rotation to the left).

It should be noted that, when the limit hole 401 is circular, the maximum angle of rotation of the joystick shaft 20 from a center position to all directions is the same. However, in the case that the limit hole 401 has a non-circular shape, the maximum angle of rotation of the joystick shaft 20 in different directions may be different.

The maximum rotation angle of the joystick shaft 20 is selected to ensure that target micro-switches 30 corresponding to the cardinal and ordinal directions can be triggered, and the micro-switches 30 will not be damaged by, for example, over-compression. The joystick is configured to output operation signals in eight directions. Thus, this embodiment focuses on describing the rotation angles in the eight directions. The four micro-switches 30 are located in the four cardinal directions (i.e., front, back, left, and right) of the trigger member 21, and an included angle between an ordinal direction and a cardinal direction adjacent to the ordinal direction is 45°. Since the four micro-switches 30 are located in the four cardinal directions of the trigger member 21, a distance/rotation angle required by the joystick shaft 20 to trigger the micro-switch 30 from a cardinal direction is relatively small (equivalent to right-angled sides of a right-angled triangle), while the distance/rotation angle required for the joystick shaft 20 to simultaneously trigger two micro-switches 30 from an ordinal direction is relatively large (equivalent to a hypotenuse of a right-angled triangle). In an embodiment in which the limit hole 401 is circular, the maximum angle that the joystick shaft 20 can rotate from the center position is the same in all directions). If the diameter of the limit hole 401 is relatively small such that the maximum angle that the joystick shaft 20 is configured to rotate in a cardinal direction is just sufficient to trigger the micro-switch 30 corresponding to this cardinal direction (e.g., front, back, left, or right), then the maximum angle that the joystick shaft 20 rotates in an ordinal direction would not be sufficient to trigger the two micro-switches 30 corresponding to this ordinal direction. If the diameter of the limit hole 401 is relatively large such that the maximum angle that the joystick shaft 20 is configured to rotate in an ordinal direction is just sufficient to trigger the two micro-switches 30 corresponding to this ordinal direction, then the joystick shaft 20 when rotating in a cardinal direction to the maximum angle may exceeds the designed stroke of the micro-switch 30 (i.e., the distance that the trigger member 21 may travel in a cardinal direction arrives after pressing against the micro-switch 30 may exceed the maximum stroke of the micro-switch 30 in that cardinal direction), resulting in a risk of damaging the micro-switch 30.

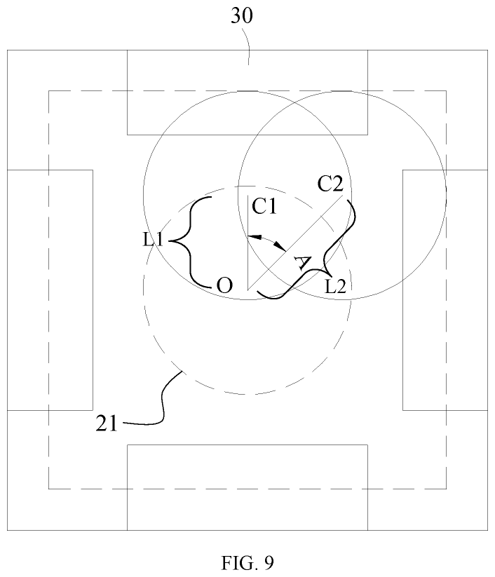

Referring to FIG. 9, on the horizontal projection, a rectangle is drawn with the four micro switches 30 as sides. The center of the trigger member 21 is initially located at a center O of the rectangle (the initial position of the trigger member 21 is shown by the dotted line of the circle in FIG. 9), and the center O of the rectangle is also the position of the axis when the joystick shaft 20 is in the centered (e.g., neutral) state. H is a height from the center O of the trigger member 21 to the rotation center of the joystick shaft 20 (see FIG. 2). When the joystick shaft 20 is rotated forward to a position where a micro-switch 30 is triggered, the center of the trigger member 21 is moved to a position C1, the joystick shaft has a cardinalrotation angle θ1 corresponding to this forward rotation, and a distance from point O to C1 is L1. When the joystick shaft 20 is rotated to a front-right position to trigger the two micro-switches 30 on the front and right sides, the center of the trigger member 21 is moved to a position C2, the joystick shaft 20 has an ordinal rotation angle 82 corresponding to this ordinal rotation, and a distance from point O to C2 is L2. An included angle formed by L1 and L2 is A. In one or more embodiments, each of the above parameters satisfies the following relations:

L1=H*tan θ1, L2=H*tan θ2, L1=L2*cos A.

In one or more embodiments, the four micro-switches 30, when connected, form a square, and the included angle A formed between L1 and L2 is equal to 45°. From this, it can be further deduced that: tan θ1=tan θ2*cos 45°.

Under the aforementioned conditions, when the joystick performs a control operation in an ordinal direction, the micro-switch 30 in the cardinal directions will not be damaged.

Considering that a stroke for triggering the micro-switch 30 has a certain range (in one embodiment, the stroke for triggering the micro-switch 30 is in a range of 1.5-2.5 mm, the dotted line of the rectangle in FIG. 9 indicates the position of the key shaft 32 when the micro-switch 30 is triggered), and considering the influence of the size of the trigger member 21 on the rotation angle of the joystick shaft 20, the above relationship is revised based on many experiments as follows: tan θ1=K*tan θ2, where 0.67≤K<1.

It should be noted that, when the position and size of the trigger member 21 and the micro-switches 30 are fixed, the control of the above-mentioned maximum rotation angle is realized through the limit hole 401 of the retaining ring 40. Thus, through the design of the size and shape of the limit hole 401 and the cooperation with the limit member 25, the rotation of the joystick shaft 20 can satisfy the above conditions.

The distance from the center O of the trigger member 21 to the hole wall of the limit hole 401 in a cardinal direction and an ordinal direction may be different. It can be understood that a distance B1 from the hole wall to the rotation axis of the joystick shaft 20 in a cardinal direction and a distance B2 between the contact point of the trigger member 21 and the micro-switch 30 to the rotation axis of the joystick shaft 20 have a linear relation, which can be obtained by conversion with the height of the rotation center, and will not be discussed here.

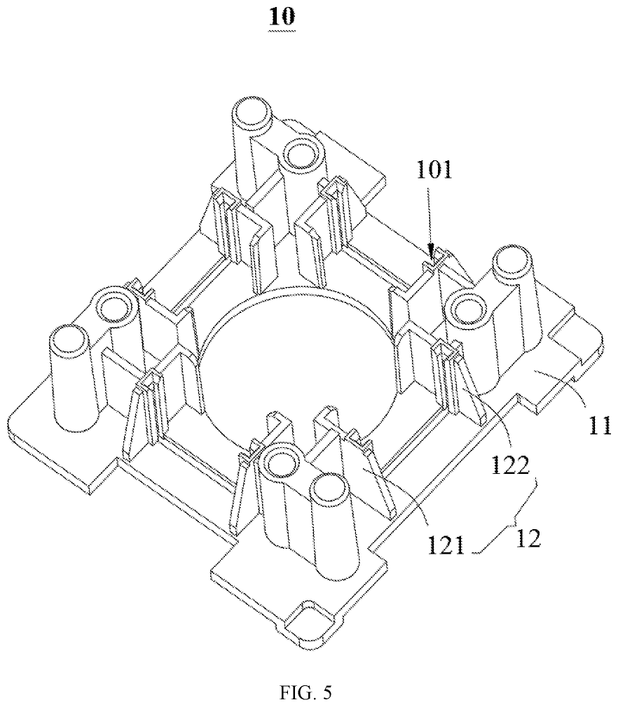

In the structure shown in FIG. 4, the limit hole 401 is in the shape of a chamfered rectangle, so that the distance from the center of the limit hole 401 to the hole wall in an ordinal direction is greater than the distance from the center of the limit hole 401 to the hole wall in a cardinal direction. In the structure shown in FIG. 5, the limit hole 401 is in the shape of an imperfect circle, and a radius in the cardinals directions is smaller than the radius in the ordinal directions. Those skilled in the art can design the shape and size of the limit hole 401 accordingly in accordance with the above-mentioned angle constraints, which are not limited here.

In the illustrated embodiment, the hole wall of the limit hole 401 is inclined (e.g., the hole wall tapers outward in a direction from a lower surface to an upper surface of the retaining ring 40), so that when the limit member 25 abuts against the retaining ring 40, the limit member 25 is in surface contact with the hole wall of the limit hole 401. In one or more embodiments, the inclination angles of the hole wall of the limit hole 401 in a cardinal direction and an ordinal direction correspond to the rotation angles of the joystick shaft 20, that is, the inclination angle in the cardinal direction is θ1, and the inclination angle in the ordinal direction is θ2 (e.g., the limit member 25 is flush or substantially flush against the hole wall of the limit hole 401 when the limit member 25 is in a maximally rotated position). In the illustrated embodiment, the hole wall of the limit hole 401 has an arc transition from the cardinal positions to the ordinal positions to ensure smooth operation of the joystick shaft 20 moving from a cardinal direction to an ordinal direction.

From the above, in the joystick, the controller having the joystick and the arcade machine having the joystick, provided by the present application, the micro-switches 30 applied in the joystick are mechanical-shaft-key switches instead of the conventional shrapnel micro-switches 30, which can effectively reduce the noise caused by the joystick and prolong the service life of the joystick. The directional output control in eight directions is realized by limiting the rotation angle of the joystick shaft 20, and it is ensured that the micro-switches 30 in the cardinal directions will not be damaged when the joystick performs control operation in the ordinal directions.

In another embodiment of the present application in which the forward rotation angle θ1 of the joystick that the is greater than the oblique rotation angle θ2, the forward rotation angle θ1 is in a range of approximately 7.5°-approximately 9°, and the oblique rotation angle θ2 is in a range of approximately 8.1°-approximately 11°.

For those skilled in the art, the forward rotation angle θ1 can be selected according to actual situations, which may be, for example, approximately 7.5°, approximately 7.6°, approximately 7.65°, approximately 7.7°, approximately 7.8°, approximately 8.0°, approximately 8.1°, approximately 8.2°, approximately 8.3°, approximately 8.4°, approximately 8.45°, approximately 8.5°, approximately 8.6°, approximately 8.8°, approximately 8.9°, approximately 9.0°, etc. The ordinal rotation angle θ2 which is greater than the cardinal rotation angle and may be set as, for example, approximately 8.1°, approximately 8.5°, approximately 8.6°, approximately 8.65°, approximately 8.7°, approximately 8.8°, approximately 9.0°, approximately 9.2°, approximately 9.3°, approximately 9.4°, approximately 9.6°, approximately 9.8°, approximately 10.0°, approximately 10.2°, approximately 10.3°, approximately 10.5°, approximately 10.6°, approximately 10.8°, approximately 10.85°, approximately 10.9°, approximately 11.0°, etc.

In another embodiment of the present application, the trigger member 21 is cylindrical, and a gap S between an outer surface of the trigger member 21 and the key shaft 32 of each of the switches 30 is in a range of approximately 0 mm-approximately 0.8 mm. It should be noted that this dimension is obtained through a measurement when the joystick shaft 20 is in a centered state (e.g., a neutral state). In an embodiment in which the positions of the micro-switches 30 are fixed, the larger the diameter of the trigger member 21 is, the smaller the angle 61 that the trigger member 21 rotates from the centered state (the O point position in FIG. 9) to a state in which the micro-switch 30 is triggered. The transition from a cardinal to ordinal travels a shorter distance (i.e., a distance from C1 to C2), so that the control of the joystick is more responsive. If the gap is too small, slight disturbances to the joystick may cause unintended control inputs to the game (i.e., maloperations). In contrast, controlling the diameter of the trigger member 21 within a certain range is configured to avoid such unintended control inputs to the game. For instance, in one or more embodiments, it is found that the joystick has good control performance when the gap S between the trigger member 21 and the key shaft 32 is in the range of approximately 0 mm-approximately 0.8 mm. In one or more embodiments, the gap between the trigger member 21 and the key shaft 32 is in a range of approximately 0.1 mm-approximately 0.3 mm. Those skilled in the art can adjust the gap between the trigger member 21 and the key shaft 32 by adjusting the position of the micro-switches 30 and/or adjusting the diameter of the trigger member 21. In one or more embodiments, the gap S between the trigger member 21 and the key shaft 32 may be approximately 0.1 mm, approximately 0.11 mm, approximately 0.12 mm, approximately 0.13 mm, approximately 0.14 mm, approximately 0.15 mm, approximately 0.16 mm, approximately 0.18 mm, approximately 0.2 mm, approximately 0.22 mm, approximately 0.23 mm, approximately 0.24 mm, approximately 0.25 mm, approximately 0.26 mm, approximately 0.27 mm, approximately 0.28 mm, approximately 0.29 mm, or approximately 0.3 mm.

In another embodiment of the present application, the trigger member 21 is cylindrical, and satisfies the following relation:

0.95≤r/B≤1, where r is the radius of the trigger member 21, and B is the distance from the surface of the key shaft 32 facing the trigger member 21 to the center of the joystick shaft 20 (see FIG. 2).

In combination with the foregoing, the diameter of the trigger member 21 affects the control sensitivity of the joystick. In one or more embodiments, good handling performance can be obtained when the ratio between the radius r of the trigger member 21 and the distance B from the key shaft 32 to the center of the joystick shaft 20 is in the range of approximately 0.95-approximately 1. In one or more embodiments, the ratio may specifically be approximately 0.95, approximately 0.952, approximately 0.955, approximately 0.96, approximately 0.965, approximately 0.97, approximately 0.978, 0.98, approximately 0.982, approximately 0.986, approximately 0.99, approximately 0.995, approximately 1.0, etc., although the ratio is not limited herein.

In this embodiment, the radius of the trigger member 21 is in a range of approximately 7.7 mm-approximately 7.9 mm, and the distance B from the surface of the key shaft 32 facing the trigger member 21 to the center of the joystick shaft 20 is in a range of approximately 7.9 mm-approximately 8.1 mm. In one or more embodiments, the stroke for triggering the micro-switch 30 is in a range of approximately 1.2 mm-approximately 1.5 mm, and the maximum stroke is approximately 3.5 mm.

In another embodiment of the present application, referring to FIG. 5 to FIG. 8, the fixed seat 31 is provided with a fixed strip (or fixed rib) 33, and the base 10 is provided with a fixed slot 101 which corresponds to (is matched with) the fixed rib 33.

The size of the micro-switch 30 is relatively small, and the projection of the micro-switch 30 on the four sides adjacent to the key shaft 32 is generally rectangular, so that the fixing of the micro-switch 30 is relatively difficult. In this embodiment, the fixed seat 31 is provided with a fixed strip (or fixed rib) 33. The fixed rib 33 has rectangular shape, surrounding four adjacent sides of the key shaft 32. The fixed rib 33 of the micro-switch 30 serves as a connection position, and the fixed slot 101 disposed on the base 10 is configured to match or correspond to the fixed rib 33. The fixed assembly of the micro-switch 30 is realized when the fixed rib 33 is inserted into the fixed slot 101, which achieves an effect of simplifying the structure.

In an embodiment of the present application, referring to FIG. 5, the base 10 includes a base plate 11 and four fasteners 12 connected to the base plate 11. The four fasteners 12 are arranged corresponding to the micro-switches 30. Each fastener 12 includes a first baffle 121 and a second baffle 122 respectively located on two sides of the micro-switch 30. Both the first baffle 121 and the second baffle 122 are defined with fixed slots 101. In the illustrated embodiment, the first baffle 121 and the second baffle 122 of each fastener 12 face inward toward each other.

It can be understood that the first baffle 121 and the second baffle 122 are located on two sides of the micro-switch 30 with respect to the key shaft 32, and the fixed slots 101 are carried by the first baffle 121 and the second baffle 122. In this embodiment, the base plate 11 is placed horizontally, the first baffle 121 and the second baffle 122 are perpendicular (or substantially perpendicular) to the base plate 11, and an extending direction of the fixed slot 101 is also perpendicular (or substantially perpendicular) to the base plate 11. During assembly, the base plate 11 is placed flat, the fasteners 12 are located on the carrier plate, the fixed rib 33 on two sides of the fixed seat 31 of each micro-switch are aligned with the two fixed slots 101 of the fastener 12 and then inserted downward into the corresponding fixed slots 101 to realize the fixing of the micro-switch 30. Thus, the operation is very convenient.

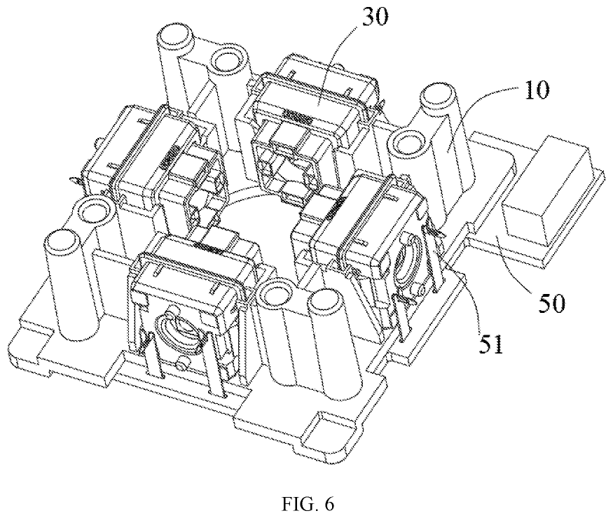

In an embodiment of the present application, referring to FIG. 2 and FIG. 6, the micro-switches 30 are electrically connected to the circuit board 50 through conductive strips or ribbons 51. In other embodiments, the micro-switches 30 may also be electrically connected to the circuit board 50 through wires, or the pins of the micro-switch 30 may be directly soldered to the circuit board 50.

In this embodiment, referring to FIG. 6, one end of the conductive strip 51 facing away from the circuit board 50 is provided with a plug-in groove. When the fixed rib 33 is inserted into the fixed slots 101 of the first baffle 121 and the second baffle 122, pins of the micro-switches 30 are inserted into the plug-in grooves of the conductive strips 51. In combination with FIG. 5, the circuit board 50 is placed horizontally on a side of the base plate 11 away from the micro-switches 30, i.e., the lower side in the view direction. The conductive strip 51 connected to the circuit board 50 extends upward, and an upper end of each conductive strip 51 is defined with the plug-in groove. The pins of the micro-switch 30 extend horizontally and are inserted into the plug-in grooves. The pins of the micro-switch and the conductive strips 51 may be electrically connected through abutment between the pins and the plug-in grooves, and may also be electrically connected through welding. In one or more embodiments, the pins and the conductive strips 51 are welded and connected to ensure the tightness of the connection between the pins and the conductive strips 51 and to reduce the vibration of the micro-switches 30 under the pressure of the joystick shaft 20, which might otherwise result in the pins separating from the conductive strips 51. The pins of the micro-switches 30 are parallel (or substantially parallel) to the circuit board 50, and both ends of the conductive strips 51 are respectively connected to the pins and the circuit board 50, so the design is intuitive and the structure can be simplified. The conductive strips 51 are connected with the pins of the micro-switch 30 by defining plug-in grooves, which can simplify assembly and facilitate subsequent welding operations.

The above descriptions are only preferred embodiments of the present application and are not intended to limit the present application. Any modifications, equivalent replacements and improvements made within the spirit and principles of the present application shall be included within the protection scope of the present application.

Reference signs in the figures are listed as follows:

10—base; 101—fixed slot; 11—base plate; 12—fastener; 121—first baffle; 122—second baffle; 20—joystick shaft; 21—trigger member; 22—joystick ball; 23—hemispherical member; 24—return member; 25—limit member; 30—micro-switch; 31—fixed seat; 32—key shaft; 33—fixed rib; 40—retaining ring; 401—limit hole; 50—circuit board; and 51—conductive strip.

What is claimed is:

1. A joystick, comprising:
a base;
a joystick shaft in operable connection with the base;
a trigger member and a limit member each extending around a portion of an outer surface of the joystick shaft;
four micro-switches fixed on the base, wherein the four micro-switches are respectively located in one of four cardinal directions of the trigger member, and four ordinal directions are respectively formed between every two adjacent micro-switches of the four micro-switches, wherein each of the four micro-switches is a mechanical-shaft-key switch and comprises a fixed seat and a key shaft protruding from the fixed seat, and wherein the key shaft is configured to be pressed by the trigger member to trigger the micro-switch; and
a retaining ring configured to limit rotation angles of the joystick shaft,
wherein the joystick shaft has a cardinal rotation angle and an ordinal rotation angle, the cardinal rotation angle being a maximum rotation angle of the joystick shaft in any of the four cardinal directions, and the ordinal rotation angle being a maximum rotation angle of the joystick shaft in any of the four ordinal directions.

2. The joystick of claim 1, wherein the cardinal rotation angle and the ordinal rotation angle satisfy a relational expression expressed as tan θ1=K*tan θ2, wherein 0.67≤K<1, 81 is the cardinal rotation angle of the joystick shaft, and θ2 is the ordinal rotation angle of the joystick shaft.

3. The joystick according to claim 1, wherein the joystick satisfies conditions that comprise: the cardinal rotation angle is greater than the ordinal rotation angle, the cardinal rotation angle is in a range from 7.5° to 9°, and the ordinal rotation angle is in a range from 8.1° to 11°.

4. The joystick according to claim 1, wherein the trigger member has a cylindrical shape, and wherein a gap between an outer surface of the trigger member and the key shaft is in a range of approximately 0 mm-approximately 0.8 mm.

5. The joystick according to claim 1, wherein the trigger member has a cylindrical shape, and wherein a gap between an outer surface of the trigger member and the key shaft is in a range of approximately 0.1 mm-approximately 0.3 mm.

6. The joystick according to claim 1, wherein the trigger member has a cylindrical shape and a relational expression expressed as 0.95≤r/B≤1 is satisfied,
wherein r is a radius of the trigger member, and B is a distance from a surface of the key shaft facing the trigger member to a center of the joystick shaft.

7. The joystick according to claim 1, wherein a periphery of each fixed seat comprises a fixed rib, and the base comprises corresponding fixed slots corresponding to the fixed rib.

8. The joystick according to claim 7, wherein the base comprises a base plate and four fasteners connected to the base plate and arranged to correspond with the four micro-switches, wherein each of the four fasteners comprises a first baffle and a second baffle, the first baffle and the second baffle being located on two sides of one of the four micro-switches, and the first baffle and the second baffle form a fixed slot of the fixed slots.

9. The joystick according to claim 1, further comprising a circuit board and a plurality of conductive strips, wherein the four micro-switches are electrically connected to the circuit board through the plurality of conductive strips;
wherein one end of each of the plurality of conductive strips facing away from the circuit board comprises a plug-in groove, and
wherein, when the fixed rib of each of the four micro-switches is inserted into and in engagement with a fixed slot of the fixed slots, pins of the four micro-switches are received in the plug-in groove of each the plurality of conductive strips.

10. A controller, comprising the joystick according to claim 1.

11. An arcade machine, comprising the joystick according to claim 1.
